(19) United States
(12) Patent Application Publication
(10) Pub. No.: US 2026/0010667 A1
(43) Pub. Date: Jan. 8, 2026

(54) SOFTWARE AND METHOD FOR PLANNING AND SETTING UP ROOM AND BUILDING AUTOMATION SOLUTIONS

(71) Applicant: WAGO Verwaltungsgesellschaft mbH, Minden (DE)

(72) Inventor: Thomas HOLM, Bad Salzuflen (DE)

(73) Assignee: WAGO Verwaltungsgesellschaft mbH, Minden (DE)

(21) Appl. No.: 19/259,167

(22) Filed: Jul. 3, 2025

(30) Foreign Application Priority Data
Jul. 3, 2024 (DE) 10 2024 118 852.9

(51) Int. Cl. G06F 30/13; G06F 111/20

(52) U.S. Cl. CPC G06F 30/13; G06F 2111/20

(57) ABSTRACT

Software for planning and setting up room and building automation solutions. A charging module is set up for charging a digital building information model. A configuration module, which is set up to configure building automation artifacts. A placement module is set up for placing building automation artifacts in a 3D model of the building information model. A logic module is set up to define logic for building automation artifacts and dependencies between building automation artifacts in the building information model. A method for planning and setting up room and building automation solutions is also provided.

This nonprovisional application claims priority under 35 U.S.C. § 119(a) to German Patent Application No. 10 2024 118 852.9, which was filed in Germany on Jul. 3, 2024, and which is herein incorporated by reference.

### FIELD OF THE INVENTION

The present invention relates to the field of building automation and in particular to a software and a method for planning and setting up room and building automation solutions with the help of a building information model.

### DESCRIPTION OF THE BACKGROUND ART

In the past, large paper plans and lists derived from these were used in the planning of automation solutions for commercial and residential buildings. Recently, digitization has also found its way into this area.

The process of digital building information modeling (BIM) is used for the planning of buildings. Ideally, this process envisages that all trades involved in planning and construction work with a common data system, the building information model. All planning iterations and results are to be stored in this data system, so that cross-trade communication is enabled and errors are reduced.

The modeling of a building in the context of BIM is carried out using the “Industry Foundation Classes” (IFC) data model. Each trade models the trade-specific results and intermediate results in the IFC data model and hands them over to the BIM manager responsible for the project. The latter merges the various models and identifies planning errors or necessary coordination among the trades.

In the automation technology trade, too, there is a need to synchronize the trade-specific planning process with the BIM process. However, only parts of the automation system can currently be mapped in IFC. This includes, above all, the planning results that have an impact on the 3D space, i.e., the installation of the hardware of the automation system in the building.

In the course of the “Internet of Things” trend, buildings are increasingly controlled digitally and virtually. However, this requires extensive setup and programming of the necessary components of the automation systems, which is usually only carried out after the hardware has been installed in the building.

### SUMMARY OF THE INVENTION

It is therefore an object of the present invention to support the planning process in room and building automation by means of software and thereby in particular to simplify the planning and programming of a digital and virtual control system of a building.

The above object can be achieved, in an example, by a software for planning and planning room and building automation solutions, having a loading module set up for loading a digital building information model, a configuration module set up for configuring building automation artifacts, a placement module planned for placing building automation artifacts in a 3D model of the building information model and a logic module that is set up to define logic for building automation artifacts and dependencies between building automation artifacts in the building information model.

Using such software, artifacts of the building automation can be placed at a suitable location in the digital 3D model of the building information model and thus assigned to a specific location in the later building.

The loading module is set up to load a building information model. This allows for the software to load a building information model and supplement it with the planning of the building automation.

In addition, dependencies between artifacts and logic for the artifacts can also be defined. For example, artifacts can be logically related to each other, so that an event of one artifact triggers a reaction of another artifact.

In a very simple explanatory example, a short actuation of an artifact light switch could cause an artifact lighting group to be switched on by an artifact control at a certain light intensity. Another prolonged operation of the light switch when the lighting group is already on could instruct the controller to control the brightness of the lighting group. Another short actuation of the light switch when the lighting group is already on could instruct the controller to turn off the lighting group.

Such logical and installation dependencies of the artifacts can be defined with the logic module and thus added to the building information model already in the planning phase. During the construction of the building, the planned artifacts can then be correctly installed and wired on the hardware side. Once this has been done, the logic stored in the building information model can be used for programming, preferably automatic, and/or configuring the corresponding artifacts. In the example above, the controller could be automatically configured and programmed based on the logic present in the building information model. This eliminates the need for manual programming, avoids errors, and reduces programming and setup time. The planning process can thus directly support the subsequent commissioning of even complex control tasks in the course of the “Internet of Things”. In addition, the required hardware and installation can be adapted precisely to the control functions required later. In the simple example above, the required logic can be used to specify the type of light switch, for example a button instead of a toggle switch.

The placement module can be set up to instantiate an artifact of the building automation in the building information model. By placing an artifact in the 3D model, a corresponding instance of the artifact is simultaneously created to insert into the building information model.

The placement module can be set up to display a 3D view and/or a 2D view and/or a section view along an axis of the 3D model of the building information model. This allows for the planner to select the view that is advantageous for planning the building automation of a particular area of the building.

Preferably, the dependencies between artifacts can have hierarchies. This allows for structures of artifacts to be created that facilitate planning, are easy to search and reuse. For example, an artifact may have one or more sub artifacts that are subordinate to it.

Preferably, the logic can have a control program for an artifact. This means that control programs for programmable artifacts, such as controllers, PLCs, industrial PCs, or the like, can be stored in the building information model as early as the planning stage of building automation. This avoids errors in hardware selection and simplifies the subsequent programming of the hardware installed in the building.

Preferably, the logic module can be set up to create an interconnectedness of artifacts in the building information model. This can be used to create logical relationships between artifacts.

Preferably, the software also can have a cloud module that is set up to load the software from a cloud. With the cloud module, the software does not have to be installed locally in its entirety but can be downloaded from a cloud. This ensures that the software is always up to date.

Preferably, the software also can have a publish module that is set up to publish the artifacts, logic, and dependencies to the building information model. The publish module can be used to import the planning results of building automation into the building information model, so that other users of the building information model can also access the planning results and align their plans accordingly.

Preferably, the publish module can be set up to publish data in IFC format. The IFC format ensures that other users with other applications can also view the planning results.

The publish module can be set up to export the data in IFC format and/or save it locally and/or send it as a file by email. This means that planning results in IFC format can be easily stored locally and passed on in a targeted manner.

Preferably, the software also has a setup module for setting up embodiments of building automation artifacts installed in a building based on the logic and dependencies of the artifacts stored in the building information model. This means that the software can also be used to program and configure the embodiments of building automation artifacts installed in the building. In particular, such programming and configuration can be carried out by the software essentially automatically by using the logic and dependencies of the artifacts stored in the building information model.

In particular, the above-mentioned object is further achieved by a method for planning and setting up room and building automation solutions, comprising the following steps carried out by means of software: Loading a building information model into the software; Configuring building automation artifacts; Placing building automation artifacts in a 3D model of the building information model; and Defining logic for building automation artifacts and dependencies between building automation artifacts in the building information models.

This method achieves the same benefits as the software described above. In particular, logical and installation dependencies of the artifacts and control programs are defined and thus added to the building information model already in the planning phase. This logic stored in the building information model can then be used for programming, preferably automatic, and/or configuring the corresponding artifacts.

Preferably, the method also can have a step of loading the software from a cloud. This means that the software does not have to be installed locally, or not completely, but can always be downloaded from the cloud. The software can also be provided on a non transitory computer-readable medium, for example, a computer, cdrom, ram, etc., that causes one or more processors to perform the steps of the method.

Preferably, the method also can include the step of publishing the artifacts, the logic, and the dependencies into the building information model. This means that the planning results are stored in the building information model and are available there also for other users from other trades.

Preferably, the method can include the step of setting up embodiments of building automation artifacts installed in a building, based on the logic and dependencies of the artifacts stored in the building information model. This allows for the hardware installed in a building to be automatically programmed and configured, minimizing manual activities and avoiding errors.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a structure diagram of an embodiment of a software for planning and setting up room and building automation solutions;

FIG. 2A shows a 3D model of a building of a building information model;

FIG. 2B shows a sliced 3D model of a building of a building information model;

FIG. 3 shows a configuration mask for an exemplary artifact of building automation;

FIG. 4 shows a configuration mask for another exemplary artifact of building automation;

FIG. 5 shows a sliced 3D model of a building of a building information model with a placed building automation artifact; and

FIG. 6 shows a sliced 3D model of a building of a building information model with a placed building automation artifact.

### DETAILED DESCRIPTION

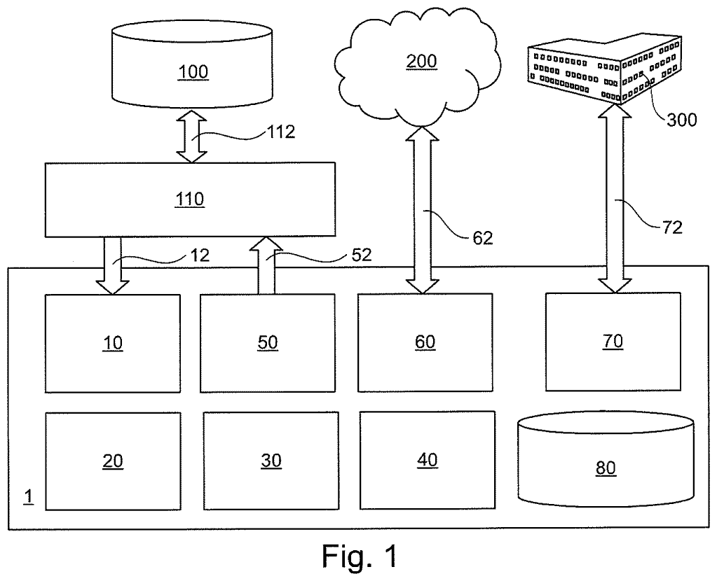

FIG. 1 shows a structural diagram of an example of a software 1 for the planning and set up of room and building automation solutions. The software 1 has a loading module 10, a configuration module 20, a placement module 30 and a logic module 40. Preferably, the software 1 can also have a publish module 50, a cloud module 60, a setup module 70 and a database 80 with artifacts 104.

In the course of building information modeling (BIM), the software 1 makes it possible to select building automation artifacts 104 from the database 80, configure them using the configuration module 20 and place them in a 3D model 102 of the building information model 100 using the placement module 30. In the process, the artifacts 104 are instantiated. Using the logic module 40, a logic can be defined for individual artifacts 104 or groups of artifacts 104. In addition, the logic module 40 can be used to define dependencies between the artifacts 104. The artifacts, logic, and dependencies are included in the building information model 100.

To load an existing building information model 100, the loading module loads the corresponding data of the building information model 100 from a corresponding data source via a BIM Manager 110, as illustrated by the arrows 112 and 12.

After the planning of room and building automation solutions has been completed, the planning results, i.e., in particular the artifacts, the logic and dependencies, are published by a publish module 50 to the BIM Manager 110, which adds them to the building information model 100. The data of the planning results are preferably published in IFC format.

This enables the mapping of planning results for room and building automation in the language of the Industry Foundation Classes (IFC) in accordance with DIN EN ISO 16739, wherein in particular the previously unforeseen modelling of logic and behavior of the artefacts in the building information model is possible. This allows for subsequent use of this logic and behavior in the setup of the concrete embodiments of artifacts 104 in the building 300.

To set up building automation embodiments of artifacts 104 installed in a building 300 based on the logic and dependencies of the artifacts 104 stored in the building information model 100, the software 1 has a setup module 70 that can communicate with the hardware installed in the real building 300, as symbolized by the arrow 72.

The software 1 is designed as a cloud application and can communicate with a cloud 200 via the cloud module 60, which also ensures location-independent use. Of course, the BIM manager 110 and the building information model 100 can also be located in a cloud.

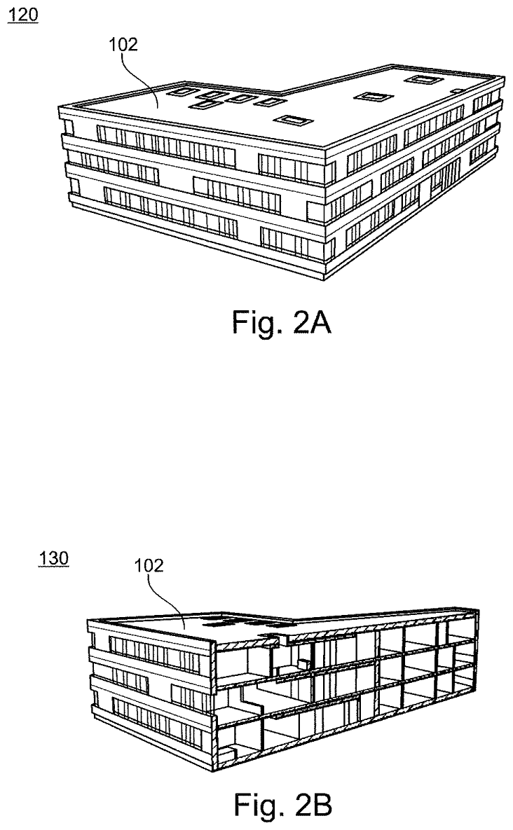

At the beginning of the BIM planning process, the automation project manager who has logged in to their workspace can view BIM models 100 of the building 300 that have already been loaded or upload new BIM models 100. The data of the building 300 to be planned are preferably received in a digital exchange format (e.g., IFC) by means of the charging module 10 and displayed to the automation project manager. For example, the project manager can view the data of the building 102 as a 3D Model 120 or as a sectioned 3D Model 130, as shown in FIGS. 2A and 2B. However, the project manager can also use the placement module 30 to display any other views and display methods at any time, for example in planes or along individual axes. This represents a basis for the start of the planning process.

The project manager can now plan according to specific trades and create solutions for this building 300 in accordance with requirements and tender documents. If several iterations of the planning result have been agreed, then after each iteration, otherwise at the end of the planning process, the results of the automation technology maintenance group with BIM relevance are transferred to the BIM Manager 110 in the IFC data format.

The solutions for room and building automation include control boxes and control cabinets, switches, lamps, drives, sensors, and other artifacts 104. These must be configured according to the desired room and building automation requirements.

For this purpose, the individual artifacts 104 of the room and building automation are selected from a database 80 and instantiated. This is done through the steps of configuring artifacts and placing artifacts 104.

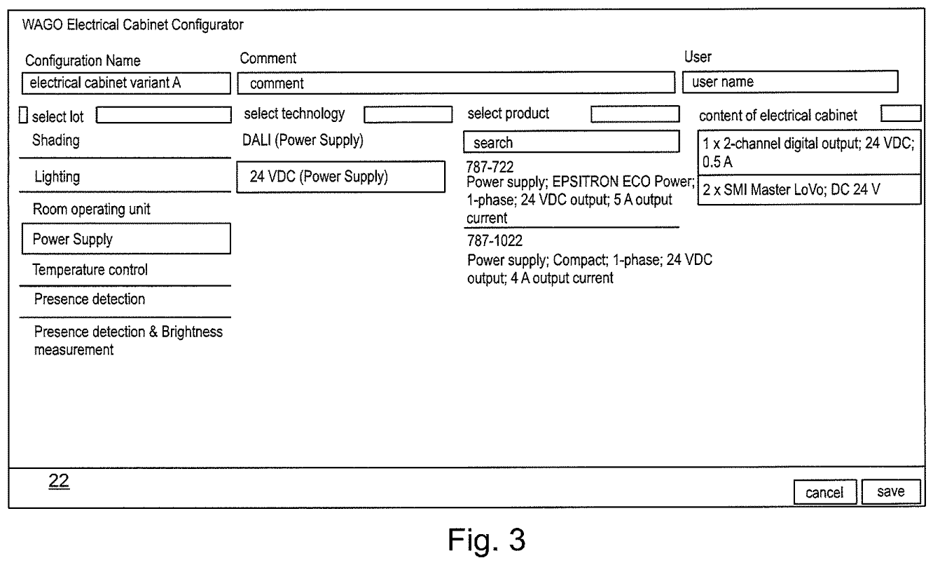

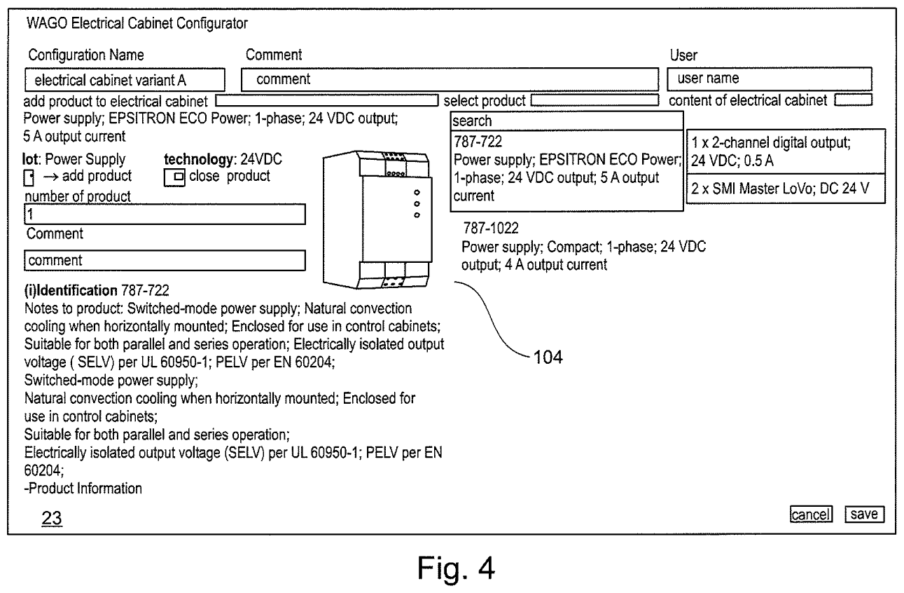

Exemplary configuration masks 22, 23 of the configuration module 20 for exemplary artifacts 104 of building automation are shown in FIGS. 3 and 4. FIG. 3 shows the configuration mask 23 for a control cabinet. The configuration mask 22 for the artifact control cabinet can be used to configure a control cabinet for the building 300. The control cabinet configuration corresponds to the procedure according to VDI813, for example. In this configuration, other artifacts, such as the power supply shown, can also be assigned and subdivided into the control cabinet artifact. This creates a dependency and a hierarchy of artifacts.

The power supply included in the control cabinet can in turn be configured by a configuration mask 23. The dependencies and configuration parameters but also control programs or other logics of the artifacts are included in the building information model 100.

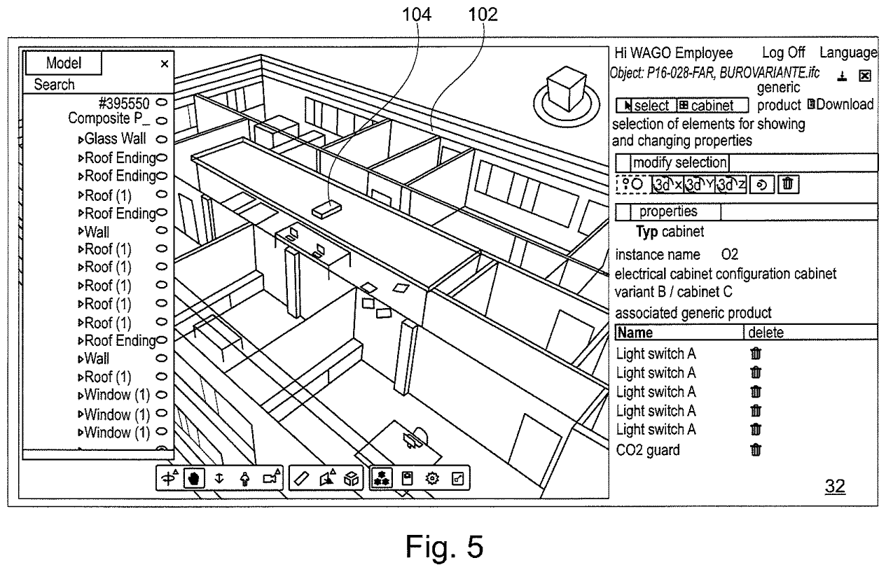

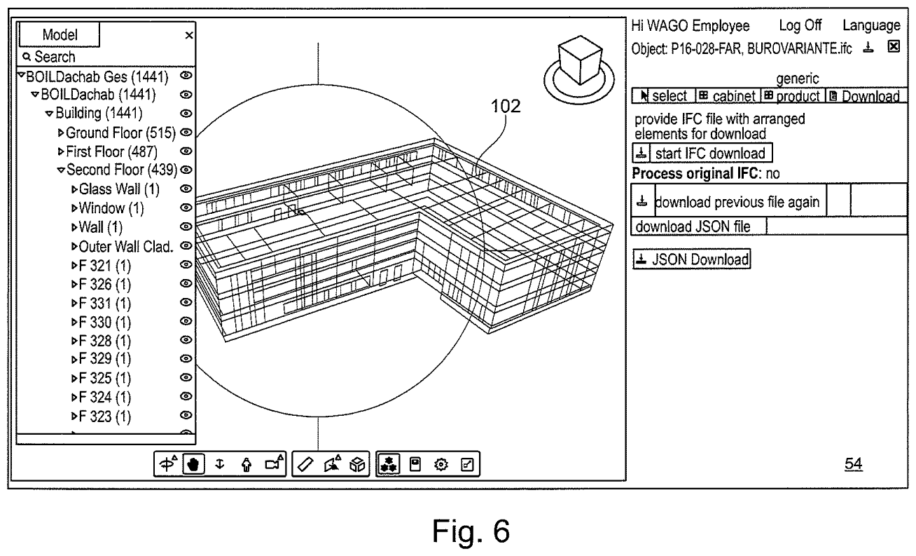

Before or after the configuration of the artifacts 104, they are placed by the project manager in a 3D model 102 of the building information model 100. Here, the project manager can select the most suitable view of the 3D model 102. In FIG. 5, the user interface 32 of the placement module 30 of the software 1 is shown as an example when an artifact 104 is placed on the ceiling of a room. The placement using the placement module 30 instantiates the artifact 104 in the building information model 100. In addition to its configuration parameters, and possibly dependencies and logic, it preferably receives a unique designation or number (ID) and the location in the 3D model as an attribute.

Since artifacts 104 are usually components of a solution, the logic module 40 can also be used to model an interconnectedness (as part of or related to). For example, switches connected to the control cabinet could be defined as “as part of” or as “related to” the control cabinet. In the example of FIG. 5, for example, five switches of the type “light switch A” and one CO2 sensor (“CO2 guard”) are assigned to the control cabinet.

All artifacts 104 instantiated from a preconfigured artifact class can also be named in order to uniquely identify or search for them.

After planning has been completed, the planning result is handed over to the responsible BIM Manager 100 by being published by the publish module 50 in IFC format, as shown by the exemplary user interface 54 of the publish module 50 of the software 1. Furthermore, the publish module 50 can export the planning result in IFC format, save it locally or send it as a file by email.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. Software for planning and setting up room and building automation solutions, comprising:
a loading module set up to load a digital building information model;
a configuration module set up for configuring building automation artifacts;
a placement module set up for placing building automation artifacts in a 3D model of the building information model; and
a logic module set up to define logic for building automation artifacts and dependencies between building automation artifacts in the building information model.

2. The software for planning and setting up room and building automation solutions according to claim 1, wherein the placement module is set up to instantiate an artifact of the building automation in the building information model.

3. The software for planning and setting up room and building automation solutions according to claim 1, wherein the placement module is set up to display a 3D view and/or a 2D view and/or a sectioned view along an axis of the 3D model of the building information model on a display.

4. The software for planning and setting up room and building automation solutions according to claim 1, wherein the dependencies between artifacts have hierarchies.

5. The software for planning and setting up room and building automation solutions according to claim 1, wherein the logic has a control program for an artifact.

6. The software for planning and setting up room and building automation solutions according to claim 1, wherein the logic module is set up to generate an interconnectedness of artifacts in the building information model.

7. The software for planning and setting up room and building automation solutions according to claim 1, further comprising a cloud module set up for loading the software from a cloud.

8. The software for planning and setting up room and building automation solutions according to claim 1, further comprising a publish module set up for publishing the artifacts, the logic, and the dependencies into the building information model.

9. The software for planning and setting up room and building automation solutions according to claim 1, wherein the publish module is set up to publish data in IFC format.

10. The software for planning and setting up room and building automation solutions according to claim 1, wherein the publish module is set up to export the data in IFC format and/or store it locally and/or send it as a file by email.

11. The software for planning and setting up room and building automation solutions according to claim 1, further comprising a setup module for setting up embodiments of building automation artifacts installed in a building based on the logic and dependencies of the artifacts stored in the building information model.

12. A method for planning and setting up room and building automation solutions comprising the following steps carried out by the software according to claim 1:
loading a building information model into the software;
configuring building automation artifacts;
placing building automation artifacts in a 3D Model of the building information model; and
defining logic for building automation artifacts and dependencies between building automation artifacts in the building information model.

13. The method for planning and setting up room and building automation solutions according to claim 12, further comprising a step of loading the software from a cloud.

14. The method for planning and setting up room and building automation solutions according to claim 12, further comprising the step of publishing the artifacts, the logic and the dependencies into the building information model.

15. The method for planning and setting up room and building automation solutions according to claim 12, further comprising the step of setting up embodiments of building automation artifacts installed in a building based on the logic and dependencies of the artifacts (104) stored in the building information model.

16. A non-transitory computer readable medium comprising the software according to claim 1.
